(19) United States
(12) Patent Application Publication
(10) Pub. No.: US 2016/0042038 A1
(43) Pub. Date: Feb. 11, 2016

(54) METHODS AND SYSTEMS FOR MANAGING ANIMALS

(71) Applicant: THE BOSTON CONSULTING GROUP, INC., Boston, MA (US)

(72) Inventors: Jeff SCHUMACHER, Manhattan Beach, CA (US); Sean COLLINS, Venice Beach, CA (US); Walter DELPH, Boston, MA (US); Henry VOGEL, Boston, MA (US); Kevin BETHUNE, Redondo Beach, CA (US); Magdalena PALUCH, Pasadena, CA (US); Andrew NAGATA, Pasadena, CA (US); Anthony PELOSI, San Francisco, CA (US); Caroline VION, Venice, CA (US)

(21) Appl. No.: 14/823,772

(22) Filed: Aug. 11, 2015

Related U.S. Application Data
(60) Provisional application No. 62/035,896, filed on Aug. 11, 2014.
(60) Provisional application No. 62/036,306, filed on Aug. 12, 2014.
(60) Provisional application No. 62/067,882, filed on Oct. 23, 2014.

(51) Int. Cl. G06F 17/30; A01K 27/00; A01K 29/00

(52) U.S. Cl. CPC G06F 17/30528; G06F 17/30554; G06F 17/30377; A01K 29/005; A01K 27/009

(57) ABSTRACT

Systems and methods for providing animal information related to at least one animal may sense, with at least one sensor of at least one device on the animal or in the animal's environment, information related to the animal. At least one device processor may automatically transform the sensed information into descriptive information describing a condition of the animal or related to the animal. The at least one device processor and/or at least one remote processor in communication with the at least one device processor may compare the descriptive information to known information relevant to the condition. The at least one device processor and/or at least one mobile device in communication with the at least one device processor may report information about the animal utilizing the descriptive information and the database information. The at least one device processor and/or the at least one remote processor may also generate a personalized recommendation related to the animal using the descriptive information and at least one of the known information and information related to the animal provided by a user.

### CROSS-REFERENCE TO RELATED APPLICATION

This application is based on and derives the benefit of the filing date of U.S. Provisional Patent Application Nos. 62/035,896 filed Aug. 11, 2014, 62/036,306 filed Aug. 12, 2014 and 62/067,882 filed Oct. 23, 2014. All of the foregoing are incorporated by reference in their entireties herein.

### BRIEF DESCRIPTION OF THE DRAWINGS

FIG. 1 is a system according to an embodiment of the invention.

FIG. 2 illustrates a method for managing animals according to an embodiment of the invention.

FIG. 3A is a device according to an embodiment of the invention.

FIG. 3B is an animal management system of a device according to an embodiment of the invention.

FIG. 3C is an animal management system of a device according to an embodiment of the invention.

FIG. 4 is a housing according to an embodiment of the invention.

### DETAILED DESCRIPTION OF SEVERAL EMBODIMENTS

The systems and methods described herein may provide automatic monitoring and management of pets or other animals. Devices (e.g., collars, collar attachments, food serving and/or storage containers, cameras, microphones, toys, implanted devices, etc.) may include specialized monitoring, processing, and reporting elements for animal management. These devices may be worn and/or used by animals being monitored in some embodiments.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, although the term “processor” may appear in the following specification, the disclosed embodiments are not limited to processors. In some embodiments, the computers used in the described systems and methods may be special purpose computers configured specifically for animal management. For example, a device may be equipped with specialized sensors, processors, memory, communication components, etc. that are configured to work together to track, monitor, and report on an animal and/or perform any of the other actions described in greater detail below.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Bluetooth, Wi-Fi, WiMax, or other wireless connection). Connections between computers may use any protocols, including connection oriented protocols such as TCP or connectionless protocols such as UDP. Any connection through which at least two computers may exchange data can be the basis of a network.

### System

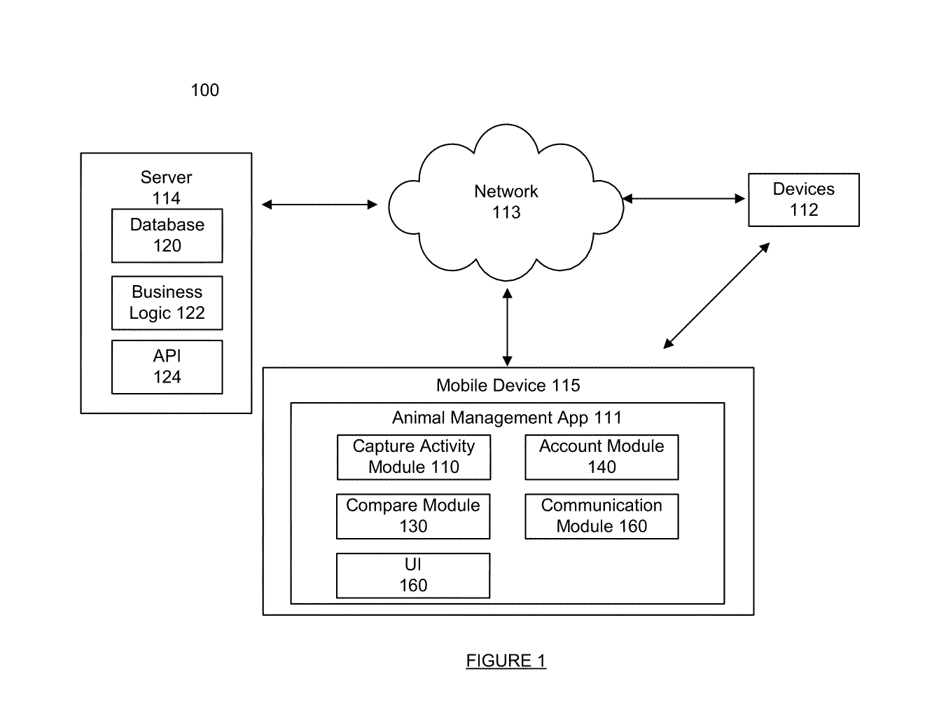

FIG. 1 is a system 100 according to an embodiment of the invention. The system 100 may include one or more computers comprising one or more processors and/or other elements. The computers may be in communication (either directly or indirectly) with each other. A network 113 may facilitate the communication in some embodiments. The system 100 may comprise an animal management application 111. The app 111 may be on a mobile device 115 (e.g., a smartphone or tablet) or other computing device. The app 111 may include a capture information module 110 which may be constructed and arranged to generate and capture information related to one or more animals from one or more devices 112 on the animal or in the animal's environment. The device 112 may track, for example, the animal's activity, sleep, location, or health, or any combination thereof. Examples of devices 112 may comprise a collar, an attachment to a collar, a food serving container, an attachment to a food serving container, a food storage container, an attachment to a food storage container, a camera, an attachment to a camera, a toy, an attachment to a toy, a microphone, an attachment to a microphone, or an implanted device, or any combination thereof. The device 112 and mobile device 115 may communicate with one another via network 113 and/or via some other connection (e.g., Bluetooth). The system 100 may also include a server 114 including a database 120 which may be constructed and arranged to store data. The server 114 may comprise business logic 122 and an API 124 allowing the server 114 and app 111 to communicate. As described in greater detail below, business logic 122 may analyze data gathered by the device and stored within the database 120 and generate insights. The data in the database 120 may comprise, for example, any data from any device 112, any data provided by the owner or the owner's agent, any data otherwise related to the one or more animals, general data about animals, any data about any product or services (e.g., such as from merchants), any data from care providers (e.g., dogsitter, health care provider), or other data, or any combination thereof. The data in the database 120 may also comprise data related to app 111 users (e.g., animal owners), such as address, credit card details, purchase history, loyalty program points accrued, product/store preferences, etc. The server 114 and its components may be components of a single, special purpose computer or may be separate and/or distributed, special purpose computers. In some embodiments, the database 120 may include several separate databases that may be linked together (e.g., a database for animal data and a separate database for owner data). Data from the device 112 may be sent from the device 112 to the server 114 via a network such as the Internet and/or may be sent from the app 111 to the server 114 via the network. In the latter case, the device 112 may first communicate the data to the app 111 via a local network. The app 111 may include a compare module 130, which may be constructed and arranged to compare data captured from devices and/or other data and compare this data to the data in the database 120. The app 111 may include an account module 140 arranged to generate and manage accounts (e.g., of animal owners, care providers, merchants, etc.). The app 111 may also include a communication module 150, which may allow the app 111 to interact with other computers, e.g. via a network such as the Internet, so that the app 111 may send and receive data. The app 111 may also include a user interface 160 which may be constructed and arranged to accept data related to animals and interact with the animal owner and/or animal agent.

The app 111 may provide a variety of data and possible interactions to the user. For example, the app 111 may provide one or more of the following features.
Comparison Database: The app 111 may match gathered information against a comparison database of AKC recognized pure breeds as well as common mixed breeds. This database may contain baseline activity, specifications (height, weight, size, etc.) and may provide the user with insight into the growth, development, and activity of their dog in relation to others. Insight may be generated by server 114 business logic 122 and/or device 112 using machine learning, for example through cross correlation of historical data and/or comparing and correlating new data collected by the device 112 with data in the database 120 to analyze the animal's behavior and changes. For example, when data is collected by the device 112 through its sensors, that data may be compared against past behavior data for the individual animal as well as behavior data for similar animals. At least some of this data may have been generated through experimental observation (e.g., by verifying that a certain behavior corresponds to certain data, such as a tail wagging producing specific sensed motions). Data generated by device 112 sensors may be gathered from one or more animals of various types, breeds, sizes, ages, etc. and/or from the individual animal over time and associated with known activities. This gathered data may be added to a library of sensor reference signals in the database 120. Sensor reference signals may include the captured signal or a description thereof along with the actual animal activity corresponding to the signal. Thus, server 114 business logic 122 and/or device 112 may be able to receive a signal from a device 112 sensor, compare the received signal to signals in the library to identify which action most closely matches with the received signal. Through machine learning, the sensor reference data in the database 120 may be continuously refined and improved to allow for more accurate behavior detection.
View Goals: The app 111 may allow the user to set, view, and maintain fitness goals for their pet.
View Stats (Training Sessions, Walks, Tricks): The app 111 may allow the user to gain insight into the cumulative, daily, monthly, or average statistics relating to the care and activity of their dog.
View Wellness Records: The app 111 may allow the user to view their dog's wellness records (wellness score, grooming, training, etc.). For example, a wellness score may be automatically generated by the server 114 business logic 122 and may be based on data such as activity data captured through the device 112 and other care metrics like compliance on meds/vaccinations, frequency of grooming, etc.
Upload/Download Records: The app 111 may allow the user to upload records from wellness visits (wellness score, grooming, training, etc.) via an API.
Link With Tracker (synch interactions between pet and parent): The app 111 may allow a user to pair the activity between their personal tracker (FitBit™, Fuel Band™, etc.) and view it in relation to the dog. Trackers may have their own API. The app 111 may have access to a tracker API and the data gathered by the tracker. Thus, the app 111 may collect this data and display it in combination with animal related data. For example, a user may be able to see both their own exercise data and their dog's exercise data when they walk their dog.
GPS: The app 111 may access an embedded global positioning chipset that may be GSM, WPPA, and/or SigFox network compatible. For example, positioning data may be used to show where an app 111 user walked their dog based on a combination of the positioning data and data gathered by the device 112 indicative of walking activity for the dog. In some embodiments, the device 112 may also include global positioning hardware and software. Thus, for example, a user may be able to locate their dog in relation to themselves using the app 111 in communication with the device 112.
IPS (indoor position sensing): The device 112 may be equipped with a sensor configured to detect the device's position in a building, room, or other defined space. This location may be communicated to the app 111, and a user of the app 111 may be able to see where the animal is located within the defined space. For example, the device 112 may include a magnetometer. Based on a previously defined electromagnetic mapping of the defined space, the electromagnetic data captured by the magnetometer may be used to locate the device 112 within the defined space. The mapping may be done using the device 112 itself and/or other devices equipped with magnetometers (e.g., smartphones). For example, systems and methods provided by IndoorAtlas™ may be used to provide this feature.
User Upload Splash Photo: The app 111 may allow the user to upload images and personalize their user interface.
Photo Timeline: The app 111 may provide the user with a timeline of their pet's photos.
Marketplace Curated Products and Collection Capsules: The app 111 may match a dog's specificities in terms of breed, and/or age, and/or weight, and/or activity and/or other relevant information with suggested items.
Marketplace One-Click Purchases: The app 111 may provide a captive marketplace allowing for in-app purchases.
Marketplace Smart Recommendations (personalization engine): The app 111 may monitor click through behavior to make recommendations that are relevant to the user and their pet. In some embodiments, the app 111 and/or server 114 business logic 122 may make recommendations after performing analysis on user choices similar to that disclosed in U.S. Patent Application No. 2013/0051537, entitled “Campaign Manager”, the entirety of which is incorporated by reference herein. The click through behavior may be combined with animal information gathered by the device 112 to further target recommendations. For example, server 114 business logic 122 and/or device 112 may determine that an animal is scratching unusually often based on sensed motion data and information in the database 120 matching the sensed motion to the scratching activity. The server 114 business logic 122 and/or device 112 may further use information in the database 120 (e.g., information associated with similar scratching events in similar animals) to determine that the scratching suggests the presence of fleas. Based on the presence of fleas and past purchases and/or actions of the user in the app 111, the server 114 business logic 122 may generate flea control product recommendations for the user and/or may make the flea control products available for purchase through the app 111. In another example using the same process, detection of excessive food consumption without weight change may suggest a different type of food should be given to the animal, and the recommendation may suggest more appropriate foods for purchase. Other activities by the animal and/or user may be used to identify recommendations. For example, in addition to detected animal activity, user-reported activity (e.g., reporting administration of medicine or giving of treats via app 111 or device 112 input, etc.) may be used to generate recommendations (e.g., purchase more medicine or treats, schedule vet appointment, etc.).
Marketplace Food Subscription: The app 111 may enable the user to find, try, and order food and/or other frequently purchased items to be delivered on a recurring basis.
Community Search Answers to Questions: The app 111 may provide a dynamic database of user submitted questions and answers that may be curated by a third-party content partner.
Curated Articles and Content: The app 111 may provide a dynamic database of articles that may be curated by a third party content partner.
Articles and Content Smart Recommendations: The app 111 may match dog's specificities in terms of breed, and/or age, and/or weight, and/or activity and/or other relevant information with articles and other types of content.
Community Social Media (Instagram, Twitter, etc.): The app 111 may allow a user to log-in to third-party social media providers and share in-app data through the linked social media services.
User Community: The app 111 may allow a user to share updates with or respond to updates with other dog owners who are part of the community directly on the app 111. For example, updates may include pictures, videos, links and/or text about their animal.
Community Dog Friend Map: The app 111 may determine and suggest the closest park calculated by GPS, user reviews, and shared user data.
Community Play Date: The app 111 may allow a user to schedule a play date between their dog and another dog.
Community Send a Treat: The app 111 may allow a user to send a virtual treat to another user (e.g., similar to a Facebook Poke).
Community Lost Dog Location: The app 111 may allow a user to post information about a missing dog, and other users may be notified via their app 111 when local dogs are lost. The notifications may include contact information for the owner of the missing pet.
Training How-To: The app 111 may include a dynamic database of how-to videos to help users train their pet.
Training Achievement Levels: The app 111 may reward users with badges and rewards to encourage repeat use.
Food Journal: The app 111 may allow users to track meals and treats
Caloric Intake: The app 111 may allow users to visualize caloric intake
Caloric Outtake: The app 111 may allow users to visualize calorie expenditure

### Animal Management Method

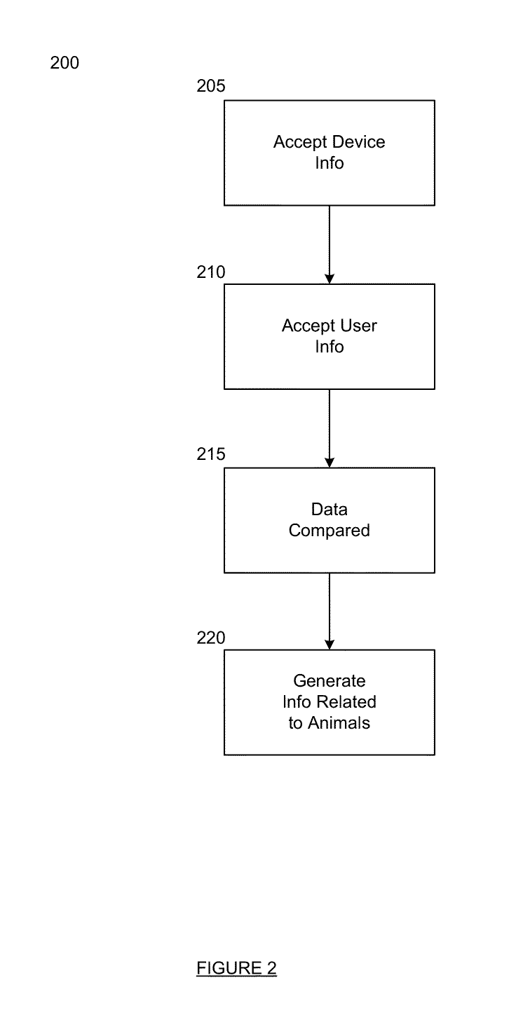

FIG. 2 illustrates a method 200 for managing animals according to an embodiment of the invention. In 205, device information gathered from devices is accepted. In 210, user information from users about animals they are managing or otherwise interested in is accepted via the app 111 and sent to the server 114. In 215, the device information, the user information, and other information already stored in database 120 is compared by the business logic 122. In 220, information related to the animals is generated by the business logic 122 using the compared information. This information comprises information gathered by the device(s) such as: information related to any food or medical needs, social opportunities, products, or services, or any combination thereof. In some embodiments, if action needs to be taken for the animal (e.g., buy food, take to vet), or if an opportunity for the animal or animal owner is available (e.g., a coupon, appointment, etc.), a color or other alert can be shown on the device, on a mobile interface, or sent to the user electronically (e.g., in an email), or a combination thereof.

In some embodiments, the processing of actions 215 and 220 may be performed by the device 112 instead of, or in combination with, the server 114 business logic 122. In this case, data stored in the database 120 may be sent to the device 112, the device 112 may compare the received data with data the device 112 has collected about the animal, and the device 112 may generated information related to the animal using the compared information. For example, if the animal is in poor health and urgently needs to see a vet, a red light and/or a fast flashing light may be shown on the device. In another embodiment, if the owner needs to buy food, or if the animal needs an appointment for a routine medical procedure a yellow light and/or a slow flashing light may be shown. Display of the yellow and/or slow flashing light may be based on reminders or appointments set by the user in the app 112 and/or may be automatic. For example, automatic triggering may be based on knowledge of how much food an animal should eat (based on the analysis of 215 and 220), how much the animal has eaten (based on sensed data from a device 112 in a food bowl), and information about the size of a food bag, suggesting that it may be time to buy a new bag of food. In another example, automatic triggering may be based on information about recommended frequency of grooming for the particular breed of the dog being monitored. After the appropriate amount of time has elapsed from the previous grooming session (which may have been reported and/or scheduled in the app 111), the device 112 may be triggered to display the reminder. If all is well and no actions are necessary, a green light may be shown. In some embodiments, instead of varying light color and/or flashing speed based on the type of information being conveyed, the device 112 may vary light color and/or flashing speed based on the urgency of the alert. Thus, any alert (for example, vet visit required, food needed, routine medical or grooming procedure needed) may start as a light of some color and/or speed and may change as time elapses without acknowledgement by the user. For example, an alert may start out as a solid green light and, if not acknowledged within some predefined time, may change to a slowly flashing yellow light. If the yellow light is not acknowledged within some predefined time, the alert may change to a quickly flashing red light. These changes are examples only, and any light colors and/or patterns may be used.

### Device

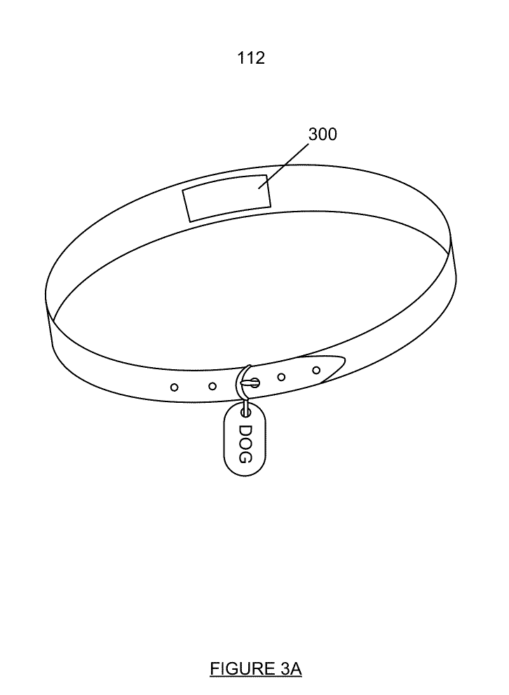

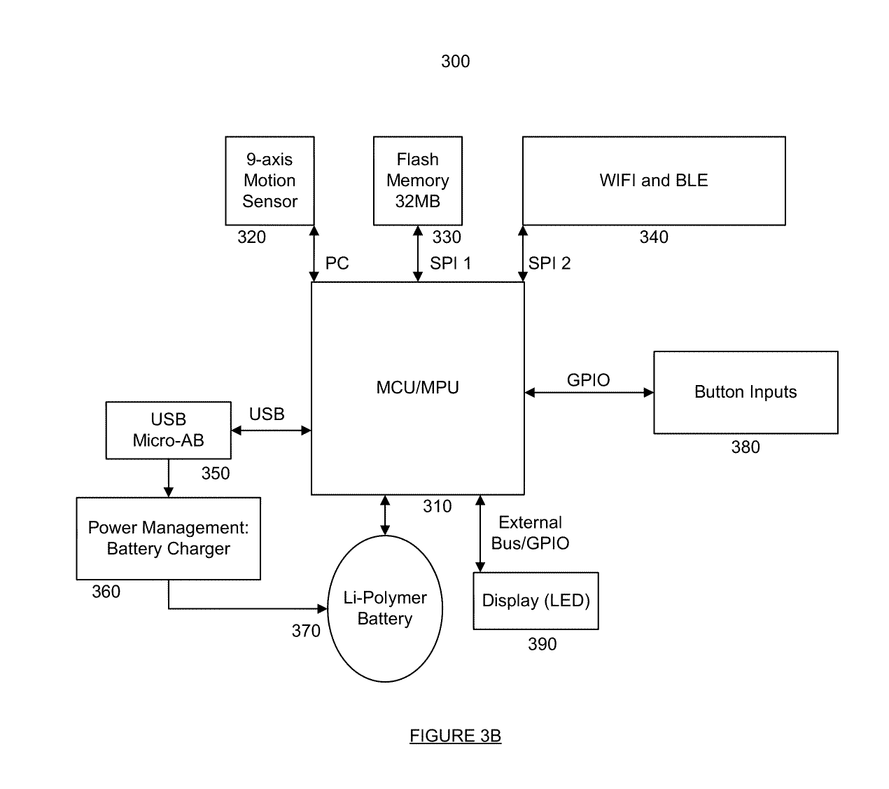

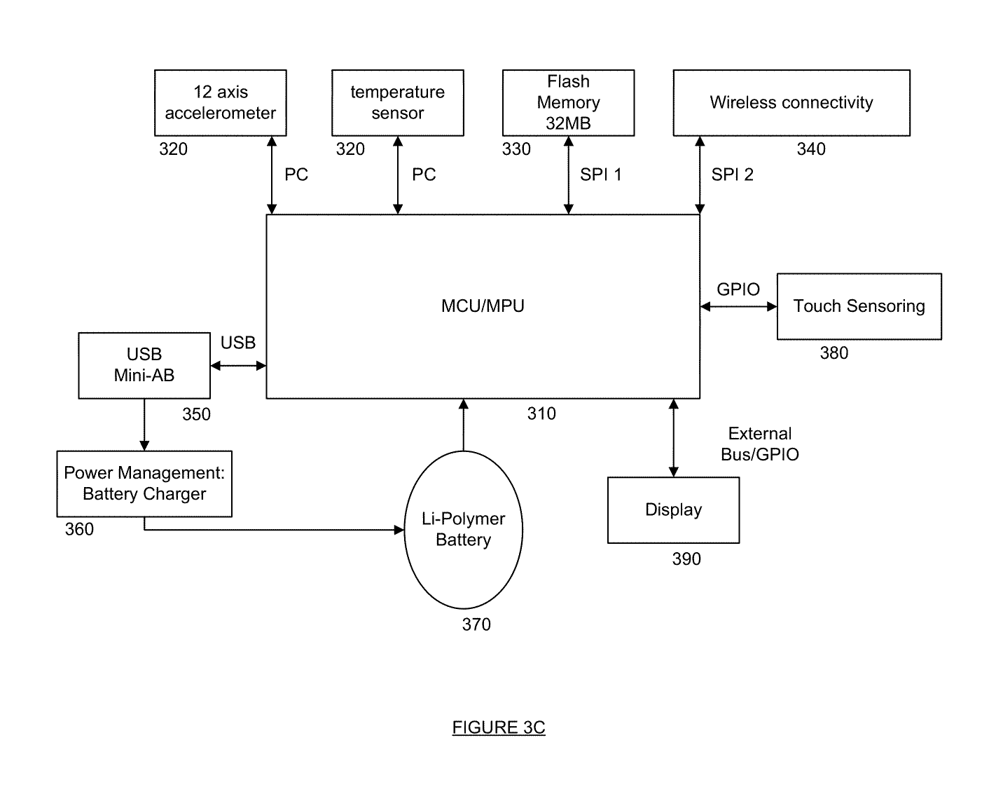

FIG. 3A is a device 112 according to an embodiment of the invention. Devices 112 may be configured to gather and report information related to the animal. For example, device 112 may include an animal management system 300. In FIG. 3A, device 112 is a dog collar, and animal management system 300 is embedded within the collar, although other devices 112 are possible as described above, and animal management system 300 may be arranged on or in device 112 in a variety of ways. For example, the animal management system 300 may be included in a tag configured to be attached to a collar, in a toy (e.g., a ball or chew toy), in a food or water bowl, in a capsule configured to be implanted in the animal's body, etc. System 300 may be placed within a waterproof or water resistant housing. In some embodiments, a plurality of systems 300 may be provided (e.g., each of a collar, toy, and bowl may include a system 300, all of which may communicate with the same app 111).

FIGS. 3B and 3C are embodiments of an animal management system 300 of a device 112. The system 300 may include a microcontroller (MCU) or microprocessor (MPU) or other processing element 310, one or more sensors (e.g., a 9-axis motion sensor and/or temperature sensor as shown) 320, memory (e.g., 32 MB flash memory as shown) 330, networking hardware (e.g., WiFi and/or Bluetooth transceivers as shown) 340, one or more data and/or power connections (e.g., USB and/or USB micro as shown and/or USB mini) 350, power management hardware (e.g., battery charger as shown) 360, power supply (e.g., Li-polymer battery as shown) 370, input hardware (e.g., one or more buttons or a touchscreen as shown) 380, and/or output hardware (e.g., a display as shown, for example multicolor LEDs, simple RGB LEDs, and/or a screen, or a speaker or vibration motor) 390. Those of ordinary skill will appreciate that much of the hardware shown (e.g., the specific types of processor, sensor, memory, networking hardware, connections, power supply and support hardware, and I/O) are examples only, and different hardware elements may be provided in other embodiments.

The system 300 may perform the method of FIG. 2 in combination with the app 111. For example, the system 300 may sense data using the sensor 320, process the sensed data using the processor 310, and store the processed data in the memory 330. This processed data may be transmitted to the capture information module 110 via the networking hardware 340 (step 205 of FIG. 2). After further processing by the app 111 associated with the capture information module 110 (steps 210-215 of FIG. 2), the app 111 may generate and display alerts and/or information to the user of the app 111 (step 220 of FIG. 2). Additionally, further processing (steps 210-220 of FIG. 2) may be performed by the processor 310 itself in some embodiments. For example, data may be entered (step 210 of FIG. 2) via the input hardware 380, and alerts and/or information may be conveyed to a user (step 220 of FIG. 2) via the output hardware 390. The processor 310 may be a special purpose processor configured to perform this method 200 while being embedded in or attached to device 112. Also, as described above, steps 210-220 of FIG. 2 may be performed by server 114 business logic 122.

Sensor 320 may include a motion sensor, for example a 9-degree of freedom, 6-axis accelerometer, four 3-axis accelerometers, and/or a 9-axis MEMS device such as the Invensense™ MPU-9150 (including an accelerometer, gyrometer, and magnetometer). The motion sensor may sense data useful for complex activity detection, such as 3D motion data. For example, processor 310 and/or server 114 business logic 122 may be able to detect complex activity such as eating, drinking, rolling over, sitting, standing, barking, scratching, licking, panting, head shaking, laying down, shaking, tail wagging, jumping, belly rub request, belly rub received, etc., based on detected motion. The motion sensor data may also indicate physiological data such as heart rate and breathing rate. The processor 310 and/or server 114 business logic 122 may use this detected activity to gauge the animal's health and activity level. For example, the processor 310 and/or server 114 business logic 122 may determine that the animal is unusually lethargic and signal that the animal needs medical attention via the display 390 and/or app 111 as described above. In another example, the processor 310 and/or server 114 business logic 122 may determine that the animal is scratching often and therefore likely has fleas and signal that the animal needs medical attention via the display 390 and/or app 111 as described above. In another example wherein the sensor 320 is part of a system 300 installed in a food bowl, motion data reported by the sensor 320 may be analyzed by the processor 310 to determine when the animal starts to eat and finishes eating and/or other food consumption behaviors. The processor 310 may cause the display to indicate that the bowl is empty, so the owner knows the animal has eaten and/or knows to refill the bowl. In another example wherein the sensor 320 is part of a system 300 installed in a dog toy, motion data reported by the sensor 320 may be analyzed by the processor 310 to collect and report training and play activity data. In another example, the sensor 320 may be part of a system 300 installed in a monitoring device such as a camera and/or microphone. The processor 310 may trigger the camera or microphone to record the animal (e.g., photos, audio recordings, videos) based on a detected animal proximity, user command, and/or at preset times or intervals.

Data may be stored in the memory 330 and reported to the owner (e.g., via the app 111), so the owner can view the animal's activity history (e.g., to make sure the animal is meeting fitness goals or eating at the proper time, etc.) and/or to the server 114 for storage and/or processing. For example, a weight score may be given to any dog trying to achieve a new weight. The amount of food the dog eats is tracked through the collar system 300 and connected bowl system 300. At the end of each week, the dog may be weighed, and the dog's performance may be compared to its tracked eating habits. This data may also be used in the community features of the app 111. For example, dogs meeting their goals may have a higher score and may be highlighted as exemplars in the community. Owners may be challenged to do the right thing for their pet. The community features of the app 111 may also allow owners to opt-in to breed specific data gathering. Pet owners and their pets may become gatherers of data through the system 300, contributing to a vast database of machine learning data. As the database grows, relevant data may be fed back to the processor 310 via the networking hardware 340, and the ability for the system 300 to sense healthy versus unhealthy movement may increase. Once a trusted and accurate database is in place, it can be used to offer suggestions and recommend purchases in a given marketplace. Dietary concerns and general wellbeing may be personalized through the app 111 and/or inputs 380, allowing owners to receive expert advice on the topics most relevant to their dogs, including advice triggered by data gathered by the system 300. In some cases, data that has been sent to the database 120 and stored there may be purged from the memory 330 to make room for new data.

Sensor 320 may include a temperature sensor configured to register the animal's skin temperature when the device 112 is in contact with the animal (e.g., when the collar is worn). Temperature data may be processed by the processor 310 and/or server 114 business logic 122 to reveal information about the animal's health (e.g., whether the animal has a fever based on having a higher than expected temperature for the species or breed and/or based on a higher registered temperature than is typical for the individual animal).

In some embodiments, the app 111 may provide external data for comparison against the individual animal's collected data. For example, in the case of a dog, gathered information about the individual dog may be compared against a comparison database of AKC recognized pure breeds as well as common mixed breeds. This database may contain baseline activity, specifications (height, weight, size, etc.) and may provide the user with insight into the growth and development of their dog in relation to others. The app 111 may also provide animal wellness records in combination with the gathered data. For example, the app 111 may allow the user to view their dog's wellness records (veterinarian generated, grooming, training, etc.) which may be supplemented with detected activity data. Some wellness records may be uploaded into the app 111 from outside sources (e.g., the veterinarian's computer).

The network hardware 340 may include, for example, a WiFi and Bluetooth 4.0 combo chip or a separate WiFi chip and Bluetooth LE chip (e.g., Nordic nRF51822). The processor 310 may switch between WiFi and Bluetooth for communications with other devices. In some cases, either WiFi or Bluetooth may be selected based on the detected presence of corresponding networks in the area of the system 300. When both network types are present, processor 310 may prefer Bluetooth over WiFi to optimize battery life in some embodiments, or processor 310 may favor WiFi over Bluetooth for extended range and/or data throughput. In some embodiments, processor 310 may function both as the main processing element for the system 300 and as the embedded controller within the Bluetooth transceiver.

### Housing

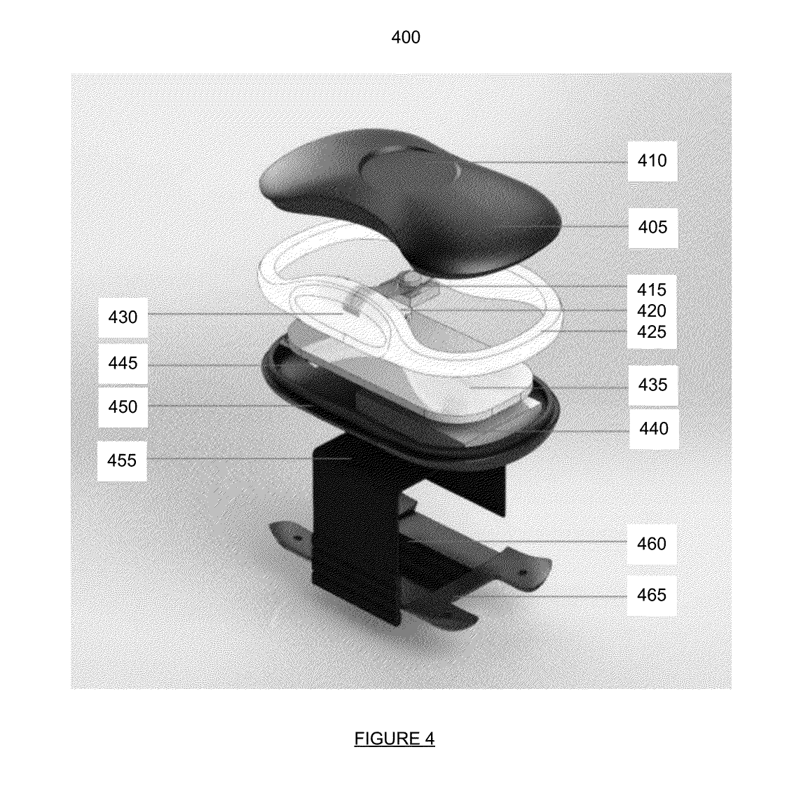

FIG. 4 is a housing 400 according to an embodiment of the invention. As noted above, in some embodiments the system 300 may be embedded in an object such as a collar, tag, bowl, etc. In other embodiments, the system 300 may be embedded in a housing 400 configured to be attached to a collar or other object. The housing 400 may be constructed and arranged to provide the input 380 as a pinch button, wherein a user may squeeze or pinch the housing 400 to actuate the button and, for example, acknowledge an alert being provided by the system 300. The pinch button may allow a user to easily actuate the button without requiring the animal to hold still or without pressing the housing 400 into the animal uncomfortably.

The housing 400 may include a top case 405. For example, the top case 405 may be a hard case element made of structural hard plastic such as polycarbonate, metal, or some other suitable material. In some embodiments, the top case 405 may include an indentation 410. This may reduce the volume of the housing 400, accept stickers for personalization, and/or improve grip. The finish of the indentation 410 may vary from the remaining surface of the top case 405.

The housing may include a pinch switch assembly 415, which may include a mechanical switch (i.e., input 380) located on a PCB of the device 300 and a switch trigger that may bend down to actuate the switch only when pinched on both sides. Requiring a pinch from both sides to actuate the switch may reduce the likelihood of accidental switch actuation by motion of the animal, touching of the housing, etc. The switch trigger may be made of metal or some other material. One or more RGB LEDs 420 may be located on either side of the pinch trigger and may serve as the display 390. LEDs 420 be recessed into a middle transparent ring 425 that separates the top case 405 from the bottom case 450 to channel illumination into the edges of the housing 400. The middle transparent ring 425 may be made of silicon-like material (strong but with soft, rubberized feel) or some other suitable material. The middle transparent ring 425 may be flexible in order to simulate the “pinch” feel to the switch. The middle transparent ring 425 may be transparent with the back surface painted white or having a reflective coating to reflect and channel light in some embodiments. Smoky tint may be applied to the middle transparent ring 425 to avoid UV-caused yellowing over time. The middle transparent ring 425 may act as an O-ring to increase waterproofing in some embodiments. The middle transparent ring 425 may be an overmolding to the top case 405, instead of being independent, in some embodiments. A membrane button 430 may cover the switch in some embodiments.

The pinch button formed by the pinch switch assembly 415 and middle transparent ring 425 may be used to acknowledge alerts as discussed above and/or may have additional uses. For example, the pinch button may be used to turn on one or more of the LEDs 420 to provide a light on the animal (e.g., as a night light to allow the user to see the animal during evening walks). In some embodiments, the device 300 may register different pinch button presses as different commands. For example, a single press, a quick double press, a quick triple press, a hold, etc., could all trigger different responses by the device 300. Thus, one type of press may acknowledge an alert, another type may input that a meal has been given to the animal, and yet another may input that a treat has been given to the animal. In some cases, different presses may turn on different colored LEDs 420. In some embodiments, any type of information that may be input via the app 111 may also be input via the pinch button (e.g., food, treat, or medicine given; grooming or vet appointment attended; reporting mood of animal; etc.). For example, the input function of one or more button press types may be programmable via the app 111. The app 111 may have default commands. A user may be able to edit these commands and the edits may be conveyed to the device 300 via Bluetooth or other network connection.

A PCB 435 may be enclosed towards the center of the housing's height (on top of the Battery 440, which may serve as power supply 370 for the device 300) and may facilitate dual-side mounting of system 300 components.

The housing 400 may include a bottom case 450. For example, the bottom case 450 may be a hard case element made of structural hard plastic such as polycarbonate, metal, or some other suitable material. A USB door 445 may be located on the bottom of the bottom case 450. The housing 400 may include Velcro 455 or some other attachment element. The example Velcro 455 shown may include a finished, ribbed edge that can be shortened to match different sizes of collars. Velcro 455 may have a ribbed rubber insert in the center to prevent the Velcro 455 from coming undone easily. The housing 400 may include a Velcro attachment loop 460, for example made with thin and strong plastic with some level of flexibility. The Velcro attachment loop 460 may be screwed, welded, or otherwise attached to the bottom of the bottom case 450 to the side of the USB door 445. The housing 400 may also include a ribbed surface lock/traction element 465 to lock Velcro 455 in place.

### Example Features

The following tables and examples include additional features that may be provided in some embodiments and/or additional description of some features described above. For example, the events in Tables 1-4 may match animal activity that is identified through sensor 320 data gathering and subsequent analysis by processor 310 and/or server 114 business logic 122 based on data in the database 120. When such activity is identified, it may be logged in the database 120.

Table 1 is an example set of data recording features according to an embodiment of the invention.

TABLE 1
Data Recording

| Feature | Description |
|---|---|
| Event Log | The device may record various types of events as they occur |
| Recording | in chronological order in one or more event log files |
| | (depending on event type) until the allocated memory for a |
| | particular event log file is full and then replace the earliest |
| | entries with new events. Timestamps may be recorded in |
| | seconds since epoch (Unix or other) for more efficient |
| | memory usage and later converted to ISO 8601 or native OS |
| | time format in supporting software (cloud backend, mobile |
| | application, etc.). |
| Event Log | In addition to using timestamps based on UTC time, the |
| Time | device may also have knowledge of the local time offset for |
| Zone | the purposes of recording events as well as triggering time |
| Support | of day based alerts. This could either be a global time zone |
| | offset value (easy but retroactively causes all recorded data |
| | to be same time zone), time zone offset event type (supports |
| | historical time zone changes but tricky to implement), or |
| | recording time zone offset along with UTC time for each |
| | event (supports historical time zone but wastes precious |
| | memory if using processor's internal memory). This allows |
| | the device to function as flexibly as possible (when dealing |
| | with time zone changes) as well as supporting software or |
| | 3^{rd} party applications that may want to treat data |
| | summation and comparison differently, such as whether to |
| | base daily totals on current local time zone (days could be |
| | less or more than 24 hours) or a home time zone (every day |
| | will be 24 hours). |
| Event Log | The device may be able to export recorded event data upon |
| Export | request by an external source (cloud via paired Wifi router |
| | or app via paired smartphone) and support timestamp |
| | filters such as all event data before a specified timestamp, |
| | all event data after a specified timestamp, and all event data |
| | between two timestamps (in order from oldest to newest). |
| | The recommended approach for specifying timestamp |
| | parameters is ISO 8601 format in UTC time zone, though we |
| | can consider other formats (seconds since Epoch, native OS) |
| | and time zones. |
| Event | The device may detect and record 21 days' worth of |
| Type | cumulative data for 15 minute increments (HH:00:00, |
| Cumu- | HH:15:00, HH:30:00, HH:45:00). This includes but is not |
| lative | limited to movements made, calories burned, distance |
| Detailed | travelled, etc. Since the frequency and total is fixed and it |
| | may be easy to determine exactly how much memory to |
| | allocate, the device may want to separate detailed |
| | cumulative data into its own event log file to maximize |
| | memory usage. |
| Event | The device may also calculate and record 96 days of |
| Type | cumulative data for an entire day (based on local time zone) |
| Cumu- | in case detailed cumulative data is erased before it is |
| lative | uploaded, that way we at least preserve daily cumulative |
| Daily | totals for those days. Since the frequency and total is fixed |
| | and it may be easy to determine exactly how much memory |
| | to allocate, the device may want to separate detailed |
| | cumulative data into its own event log file to maximize |
| | memory usage. |
| Event | The device may detect and record about 3 weeks' worth of |
| Type | discrete activity data (single timestamped occurrence) |
| Discrete | including but not limited to scratching, barking, sit, stand, |
| Activity | lay down, etc. Since the frequency and total is not fixed and |
| | it may be hard to determine exactly how much memory to |
| | allocate, the device may or may not want to record this data |
| | in the same event log file as other event types that do not |
| | have a fixed frequency and total using a best estimate as to |
| | how much memory is needed. |
| Event | The device may detect and record about 3 weeks' worth of |
| Type | time-bound activity data (timestamped at beginning and |
| Time- | end) including but not limited to eating, drinking, chewing, |
| bound | licking, etc. Since it may be hard to determine exactly how |
| Activity | much memory may be allocated, the device may want to |
| | record this data in the same event log file as time-bound |
| | activity data using a best estimate as to how much memory |
| | is needed. Since the frequency and total is not fixed and it |
| | may be hard to determine exactly how much memory to |
| | allocate, the device may or may not want to record this data |
| | in the same event log file as other event types that do not |
| | have a fixed frequency and total using a best estimate as to |
| | how much memory is needed. |
| Event | The device may detect and record about 3 weeks history |
| Type | (for example) when a user has logged a feeding of a |
| Log Input | meal/treat mapped to a food type and quantity. Since the |
| | frequency and total is not fixed and it may be hard to |
| | determine exactly how much memory may be allocated, the |
| | device may or may not want to record this data in the same |
| | event log file as other event types that do not have a fixed |
| | frequency and total using a best estimate as to how much |
| | memory is needed. |
| Event | The device may detect and record when a user logs the |
| Type | feeding of a meal of a predetermined default type and |
| Log Meal | quantity. The default meal definition is specified in the |
| | mobile application. For example, 4 ounces of XYZ brand |
| | chicken and fish canned dog food. |
| Event | The device may detect and record when a user logs the |
| Type | feeding of a particular treat, e.g., treat 1, of a predetermined |
| Log | type and quantity. The treat 1 definition is specified in the |
| Treat 1 | mobile application. For example, 1 XYZ brand 13 oz prime |
| | cuts dog bone. |
| Event | The device may detect and record when a user logs the |
| Type | feeding of a particular treat, e.g., treat 2, of a predetermined |
| Log | type and quantity. The treat 2 definition is specified in the |
| Treat 2 | mobile application. For example, 5 pieces of XYZ brand beef |
| | jerky. |
| Event | The device may detect and record when a user logs the |
| Type | feeding of a particular treat, e.g., treat 3, of a predetermined |
| Log | type and quantity. The treat 3 definition is specified in the |
| Treat 3 | mobile application. For example, ½ package of XYZ brand |
| | 18 oz bag chicken chews. |
| Event | The device may detect and record when a user logs the |
| Type | feeding of a particular treat, e.g., treat 4, of a predetermined |
| Log | type and quantity. The treat 4 definition is specified in the |
| Treat 4 | mobile application. For example, 3 nuggets of XYZ brand |
| | chicken and fish biscuits. |
| Event | The device may detect and record when a user logs the |
| Type | feeding of a particular treat, e.g., treat 5, of a predetermined |
| Log | type and quantity. The treat 5 definition is specified in the |
| Treat 5 | mobile application. For example, 40 grams of XYZ brand |
| | lamb flavored nibbles. |
| Event | The device may detect and record about 3 weeks history |
| Type | (for example) when an alert is triggered and |
| Alert | dismissed. Since the frequency and total is not fixed and it |
| | may be hard to determine exactly how much memory may |
| | be allocated, the device may or may not want to record this |
| | data in the same event log file as other event types that do |
| | not have a fixed frequency and total using our best estimate |
| | as to how much memory is needed. |
| Event | The device may detect and record when an alert is triggered |
| Type | along with the type of alert (medicine, feed, etc.). |
| Alert | |
| Triggered | |
| Event | The device may detect and record when a user checks the |
| Type | current remaining battery level on the device. |
| Battery | |
| Check | |

Table 2 is an example set of discrete activity data recording events according to an embodiment of the invention.

TABLE 2
Discrete Data Recording Events

| Event | Description |
|---|---|
| Scratch | The device may record, with a reasonable degree of |
| Event | accuracy, when the dog performs a scratch. |
| Bark Event | The device may record, with a reasonable degree of |
| | accuracy, when the dog barks. |
| Head Shake | The device may record, with a reasonable degree of |
| Event | accuracy, when the dog's head performs a rapid shake |
| | (indicator of ear issue). |
| Lay Down | The device may record, with a reasonable degree of |
| Event | accuracy, when the dog lays down from another position |
| | (sit, stand, rollover, etc), |
| Sit Event | The device may record, with a reasonable degree of |
| | accuracy, when the dog sits from another position (lay |
| | down, stand, rollover, etc.). |
| Stand Event | The device may record, with a reasonable degree of |
| | accuracy, when the dog stands from another position (lay |
| | down, sit, rollover, etc.). |
| Jump Event | The device may record, with a reasonable degree of |
| | accuracy, when the dog jumps. |
| Rollover | The device may record, with a reasonable degree of |
| Event | accuracy, when the rolls over completely from a sit or lay |
| | down position all the way back to a sit or lay down |
| | position. |
| Belly Rub | The device may record, with a reasonable degree of |
| Request | accuracy, when the rolls over half-way onto its back from |
| Event | a sit or lay down position, likely waiting for a belly rub. |
| Belly Rub | The device may record, with a reasonable degree of |
| Receive | accuracy, when a dog receives a belly rub after |
| Event | performing a belly rub request. |

Table 3 is an example set of time bound activity data recording events according to an embodiment of the invention

TABLE 3
Time Bound Data Recording Events

| Event | Description |
|---|---|
| Start Eating Event | The device may record, with a reasonable degree |
| | of accuracy, when the dog starts eating. |
| Stop Eating Event | The device may record, with a reasonable degree |
| | of accuracy, when the dog stops eating. |
| Start Drinking | The device may record, with a reasonable degree |
| Event | of accuracy, when the dog starts drinking. |
| Stop Drinking | The device may record, with a reasonable degree |
| Event | of accuracy, when the dog stops drinking. |
| Start Chewing | The device may record, with a reasonable degree |
| Event | of accuracy, when the dog starts chewing. |
| Stop Chewing Event | The device may record, with a reasonable degree |
| | of accuracy, when the dog stops chewing. |
| Start Licking Event | The device may record, with a reasonable degree |
| | of accuracy, when the dog starts licking. |
| Stop Licking Event | The device may record, with a reasonable degree |
| | of accuracy, when the dog stops licking. |
| Start Panting Event | The device may record, with a reasonable degree |
| | of accuracy, when the dog starts panting. |
| Stop Panting Event | The device may record, with a reasonable degree |
| | of accuracy, when the dog stops panting. |
| Start Panting Event | The device may record, with a reasonable degree |
| | of accuracy, when the dog starts panting. |
| Stop Panting Event | The device may record, with a reasonable degree |
| | of accuracy, when the dog stops panting. |
| Start Body Shaking | The device may record, with a reasonable degree |
| Event | of accuracy, when the dog's body starts shaking. |
| Stop Body Shaking | The device may record, with a reasonable degree |
| Event | of accuracy, when the dog's body stops shaking. |
| Start Tail Wagging | The device may record, with a reasonable degree |
| Event | of accuracy, when the dog starts wagging its tail. |
| Stop Tail Wagging | The device may record, with a reasonable degree |
| Event | of accuracy, when the dog stops wagging its tail. |

Table 4 is an example set of cumulative activity data recording events according to an embodiment of the invention.

TABLE 4
Cumulative Data Recording Events

| Event | Description |
|---|---|
| Cumu- | The device may detect and record a set of cumulative |
| lative | activity data on a frequency of 15 minutes. For example, |
| Activity | # of accelerometer counts, calories burned, |
| Data | distance travelled, minutes of rest, minutes of |
| Recording | light/medium/heavy activity, etc. |
| Cumu- | The device may record cumulative calories burned from |
| lative | both basal metabolic burn as well as moving around based |
| Calories | on knowledge of the following: age (from DOB), gender, |
| Burned | breed, weight, height (head to toe on all fours), length (base |
| | of neck to tail) and data from the motion sensor. Accuracy |
| | may be minimum of 30% (for ex., 700-1300 calories if |
| | actual is 1000) and preferably 15%. |
| Cumu- | The device may record cumulative distance travelled based |
| lative | on the same set of knowledge used to determine calories |
| Distance | burned. This may not record distance for movements in one |
| Travelled | place, but only when the dog is actually moving in the x-y |
| | plan (forward or side-wise) over a minimum threshold. |
| | Accuracy may be minimum of 30% (for ex., 0.7-1.3 |
| | kilometers travelled if actual is 1 kilometer) and preferably |
| | 15%. |
| Cumu- | The device may detect cumulative “movements” (TBD), such |
| lative | as accelerometer counts, steps, points, etc. The device may |
| Move- | not necessarily need to record this data for syncing with the |
| ments | cloud/app since it may not be presented to the user, but it |
| | may be used to calculate in order to calculate calories |
| | burned, distance travelled, and activity levels. |
| Cumu- | The device may record cumulative minutes of rest as |
| lative | determined by activity levels being below a set minimum |
| Rest | threshold (value TBD) of a particular measurement |
| Minutes | (accelerometer counts? steps?) within a given minute. This |
| | means every minute is either categorized as a rest minute |
| | or some other activity level. |
| Cumu- | The device may record cumulative minutes of light activity |
| lative | as determined by activity levels being between a set |
| Light | minimum and maximum threshold (value TBD) of a |
| Activity | particular measurement (accelerometer counts? steps?) |
| Minutes | within a given minute. This means every minute is either |
| | categorized as a light activity minute or some other activity |
| | level. |
| Cumu- | The device may record cumulative minutes of medium |
| lative | activity as determined by activity levels being between a set |
| Medium | minimum and maximum threshold (value TBD) of a |
| Activity | particular measurement (accelerometer counts? steps?) |
| Minutes | within a given minute. This means every minute is either |
| | categorized as a light medium minute or some other activity |
| | level. |
| Cumu- | The device may record cumulative minutes of heavy activity |
| lative | as determined by activity levels being above a set maximum |
| Heavy | threshold (value TBD) of a particular measurement |
| Activity | (accelerometer counts? steps?) within a given minute. This |
| Minutes | means every minute is either categorized as a heavy activity |
| | minute or some other activity level. |

The following is a sample data recording and event log showing a combination of these event types in a single event log file. The timestamps are shown in ISO 8601 for readability.

2014-10-22T08:00:00 movements 30 distance 22 calories 13 rest 6 light 8 medium 1 heavy 0
2014-10-22T08:08:09 activity stand
2014-10-22T08:08:13 activity sit
2014-10-22T08:08:21 activity rollover
2014-10-22T08:08:37 activity belly-rub-request
2014-10-22T08:08:45 activity belly-rub-receive
2014-10-22T08:08:59 activity sit
2014-10-22T08:09:03 activity bark
2014-10-22T08:15:00 movements 68 distance 41 calories 19 rest 9 light 4 medium 1 heavy 1
2014-10-22T08:17:03 activity rollover
2014-10-22T08:17:08 activity sit
2014-10-22T08:17:17 activity bark
2014-10-22T08:24:44 activity lick start
2014-10-22T08:26:13 activity lick stop
2014-10-22T08:30:00 movements 13 distance 6 calories 8 rest 11 light 4 medium 0 heavy 0
2014-10-22T08:45:00 movements 0 distance 0 calories 7 rest 15 light 0 medium 0 heavy 0
2014-10-22T09:00:00 movements 0 distance 0 calories 7 rest 15 light 0 medium 0 heavy 0
2014-10-22T09:00:00 alert medicine trigger
2014-10-22T09:03:54 alert dismissed
2014-10-22T09:15:00 movements 49 distance 33 calories 15 rest 7 light 5 medium 2 heavy 1
2014-10-22T09:22:03 activity bark
2014-10-22T09:22:08 activity sprint
2014-10-22T09:30:00 movements 77 distance 49 calories 22 rest 5 light 3 medium 3 heavy 4

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method for providing animal information related to at least one animal, comprising:
sensing, with at least one sensor of at least one device on the animal or in the animal's environment, information related to the animal;
automatically transforming, with at least one device processor, the sensed information into descriptive information describing a condition of the animal or related to the animal;
comparing, with the at least one device processor, at least one remote processor in communication with the at least one device processor, or a combination thereof, the descriptive information to known information relevant to the condition;
reporting, with the at least one device processor, at least one mobile device in communication with the at least one device processor, or a combination thereof, information about the animal utilizing the descriptive information and the database information; and
generating, with the at least one device processor, the at least one remote processor, or a combination thereof, a personalized recommendation related to the animal using the descriptive information and at least one of the known information and information related to the animal provided by a user using the at least one sensor.

2. The method of claim 1, wherein the known information is database information gathered from other animals similar to the animal and/or gathered from the animal.

3. The method of claim 1, wherein the descriptive information comprises animal activity data, animal sleep data, animal health data, or animal location data, or a combination thereof.

4. The method of claim 1, wherein the reported information comprises a comparison of the animal with other similar animals.

5. The method of claim 1, wherein the reported information comprises a comparison of the animal's activity and/or sleep level, location, or health state, or any combination thereof with other activity and/or sleep levels, location, or health, or any combination thereof of animals of the same breed, age, or in the same location, or any combination thereof.

6. The method of claim 1, wherein the personalized recommendation comprises personalized recommendations for food, supplements, wellness products, or other animal related products or any combination thereof.

7. The method of claim 1, further comprising accepting a portion of the animal information about the animal in a user interface of the device or the mobile device.

8. The method of claim 7, wherein the portion of the animal information comprises breed, age, weight, height, or special requirements, or any combination thereof.

9. The method of claim 1, wherein content related to the animal is sent to a user via the mobile device.

10. The method of claim 9, wherein the content comprises:
information about the animal's breed, age, location, health, weight, or activity, or any combination thereof;
tips on how to deal with specific topics related to the animal;
editorial articles, photos, or videos, or any combination thereof to inform owners about relevant topics related to the animal; or
alerts related to the animal or to animal-related events; or
a combination thereof.

11. The method of claim 10, wherein the alerts are related to potential health and/or wellness issues or other animal management related events

12. The method of claim 1, further comprising connecting, with the at least one remote processor and the at least one mobile device, animal owners with other animal owners of same breed and/or animal owners facing similar topics.

13. The method of claim 1, further comprising sharing, with the at least one remote processor, the information about the animal with at least one animal care giver.

14. The method of claim 1, further comprising providing, with the at least one mobile device, a user interface.

15. The method of claim 14, wherein the user interface facilitates food purchase, facilitates animal-related products purchase, facilitates sharing animal performance with other animal owners, facilitates sharing animal performance with animal agents, establishes a support network of animal owners for the same characteristics of pet, puts animal owners in touch and facilitates meet-ups and events, or provides a channel for animal owners look for information and content vetted by a trusted network of care givers and/or experts, or a combination thereof.

16. The method of claim 1, wherein the at least one device comprises: a collar, an attachment to a collar, a food serving container, an attachment to a food serving container, a food storage container, an attachment to a food storage container, a camera, an attachment to a camera, a toy, an attachment to a toy, a microphone, an attachment to a microphone, or an implanted device, or any combination thereof.

17. The method of claim 1, wherein the at least one device is in any area where the animal is present.

18. The method of claim 1, further comprising indicating, with a display on the device, whether any action needs to be taken for the animal.

19. The method of claim 1, further comprising storing, in at least one database, the information about the animal, or an animal owner, or a combination thereof.

20. The method of claim 1, wherein the at least one sensor is configured to sense motion data, health data, temperature data, or location data, or a combination thereof.

21. A system for providing animal information related to at least one animal, comprising:
at least one sensor configured to sense information related to the animal;
at least one device processor configured to automatically transform the sensed information into descriptive information describing a condition of the animal or related to the animal; and
at least one remote processor in communication with the at least one device processor and a database, the at least one processor configured to receive the descriptive information and store the descriptive information in the database;
wherein the descriptive information is compared to known information relevant to the condition by the at least one device processor, the at least one remote processor, or a combination thereof;
wherein information about the animal is reported utilizing the descriptive information and the database information by the at least one device processor, at least one mobile device in communication with the at least one device processor, or a combination thereof; and
wherein a personalized recommendation related to the animal is generated using the descriptive information and at least one of the known information and information related to the animal provided by a user using the at least one sensor.

22. The system of claim 21, wherein the known information is database information gathered from other animals similar to the animal and/or gathered from the animal.

23. The system of claim 21, wherein the reported information comprises animal activity data, animal sleep data, animal health data, or animal location data, or a combination thereof.

24. The system of claim 21, wherein the reported information comprises a comparison of the animal with other similar animals.

25. The system of claim 21, wherein the reported information comprises a comparison of the animal's activity and/or sleep level, location, or health state, or any combination thereof with other activity and/or sleep levels, location, or health, or any combination thereof of animals of the same breed, age, or in the same location, or any combination thereof.

26. The system of claim 21, wherein the personalized recommendation comprises personalized recommendations for food, medicine, or treatment, or any combination thereof.

27. The system of claim 21, further comprising a user interface configured to accept a portion of the animal information about the animal, wherein the user interface is provided via the mobile device.

28. The system of claim 27, wherein the portion of the animal information comprises breed, age, height, weight, or special requirements, or any combination thereof.

29. The system of claim 21, wherein the at least one device comprises: a collar, an attachment to a collar, a food serving container, an attachment to a food serving container, a food storage container, an attachment to a food storage container, a camera, an attachment to a camera, a toy, an attachment to a toy, a microphone, an attachment to a microphone, or an implanted device, or any combination thereof.

30. The system of claim 21, wherein the at least one device is in any area where the animal is present.

31. The system of claim 21, wherein the at least one device further comprises a display configured to indicate whether any action needs to be taken for the animal.

32. The system of claim 21, wherein the at least one remote processor is further configured to store, in the at least one database, the information about the animal.

33. The system of claim 21, wherein the at least one sensor is configured to sense motion activity data, health data, temperature data, or location data, or a combination thereof.

34. The system of claim 21, further comprising a plurality of devices, each device comprising at least one of the sensors and at least one of the device processors.

35. The system of claim 21, wherein the at least one remote processor is configured to connect animal owners with other animal owners of same breed, age, location, activity level, conditions, or a combination of thereof and/or animal owners facing similar topics via the at least one mobile device.

36. The system of claim 21, wherein the at least one remote processor is configured to share the information about the animal with at least one animal care giver.

37. The system of claim 27, wherein the user interface facilitates food purchase, facilitates animal-related products purchase, facilitates sharing animal performance with other animal owners, facilitates sharing animal performance with animal agents, establishes a support network of animal owners for the same characteristics of pet, puts animal owners in touch and facilitates meet-ups and events, or provides a channel for animal owners look for information and content vetted by a trusted network of care givers and/or experts, or a combination thereof.

38. The system of claim 21, wherein the at least one remote processor is configured to send content related to the animal to a user via the at least mobile device.

39. The system of claim 38, wherein the content comprises:
information about the animal's breed, age, location, height, weight, or activity, or any combination thereof;
tips on how to deal with specific topics related to the animal;
editorial articles, photos, or videos, or a combination thereof to inform owners about relevant topics related to the animal; or
alerts related to the animal, or other animal-related events, or a combination thereof; or
a combination thereof.

40. The system of claim 39, wherein the alerts are related to potential health and/or wellness issues, and/or animal-related events.

41. The system of claim 21, wherein the at least one device comprises at least one pinch button.

42. The system of claim 21, wherein the at least one pinch button is configured to receive an acknowledgement of the information about the animal.
